(19) United States
(12) Patent Application Publication
(10) Pub. No.: US 2014/0294109 A1
(43) Pub. Date: Oct. 2, 2014

(54) METHOD AND APPARATUS FOR OPPORTUNISTIC INTERFERENCE ALIGNMENT (OIA) IN SINGLE-USER MULTIPLE-INPUT MULTIPLE-OUTPUT (SU-MIMO) TRANSMISSION

(71) Applicant: Electronics and Telecommunications Research Institute, Daejeon (KR)

(72) Inventors: Min Ho CHEONG, Daejeon (KR); Hyoung Jin KWON, Daejeon (KR); Jae Seung LEE, Daejeon (KR); Sok Kyu LEE, Daejeon (KR)

(73) Assignee: Electronics and Telecommunications Research Institute, Daejeon (KR)

(21) Appl. No.: 14/242,129

(22) Filed: Apr. 1, 2014

(30) Foreign Application Priority Data
Apr. 1, 2013 (KR) 10-2013-0035224
Mar. 27, 2014 (KR) 10-2014-0035950

(51) Int. Cl. H04B 1/04; H04B 7/04

(52) U.S. Cl. CPC H04B 1/0475; H04B 7/0413
USPC 375/267

(57) ABSTRACT

A method and apparatus for opportunistic interference alignment (OIA) in single-user multiple-input multiple-output (SU-MIMO) transmission, the method including selecting an interference space, broadcasting information on the selected interference space, selecting a user terminal to be assigned a transmission opportunity for each subchannel based on leakage of interference (LIF) information when a request to send (RTS) message including the LIF information is received from at least one user terminal, and transmitting data to the selected user terminal.

### CROSS-REFERENCE TO RELATED APPLICATIONS

This application claims the benefit of Korean Patent Application No. 10-2013-0035224, filed on Apr. 1, 2013, and Korean Patent Application No. 10-2014-0035950, filed on Mar. 27, 2014, in the Korean Intellectual Property Office, the disclosures of which are incorporated herein by reference.

### BACKGROUND

1. Field of the Invention

The present invention relates to a method for opportunistic interference alignment (OIA) in a wireless local area network (WLAN) and a method of designing an energy-efficient transmission vector.

2. Description of the Related Art

A local area network (LAN) may be divided into a wired LAN and a wireless LAN. The wireless LAN, also referred to as WLAN, refers to a method of performing communication using radio waves in a network, without a cable. The WLAN has been introduced to alleviate difficulties in installment, maintenance, and relocation caused by cabling. With an increase in mobile users, the necessity for the WLAN is gradually increasing.

A WLAN includes an access point (AP), and a user terminal. The user terminal may also be referred to as a station (STA). The AP refers to a device configured to transmit radio waves to enable WLAN users within a transmission distance to access the Internet and use a network. The AP acts as a base station for cellular phones or a hub of a wired network. A wireless high-speed Internet service provided by an Internet service provider (ISP) has an AP installed in a service area.

The terminal may be provided with a WLAN card to perform wireless network communication, and may include, for example, a personal computer (PC) including a laptop, a cellular phone, and a personal digital assistant (PDA).

The most widely used WLAN standard is an Institute of Electrical and Electronics Engineers (IEEE) 802.11 standard, which defines specifications on a media access control (MAC) and a physical layer constituting a WLAN.

A MAC layer defines rules and an order to be followed when a terminal or a device using a shared medium uses/accesses the medium, thereby enabling an efficient use of the capacity of the medium.

A basic constituent block of an IEEE 802.11 network is a basic service set (BSS). In the IEEE 802.11 network, there is an extended service set that extends a service area by connecting an independent network, for example, an independent BSS, to an infrastructure network, for example, an infrastructure BSS. In the independent network, terminals within the BSS may perform communication directly with each other. In the infrastructure network, an AP may be involved in communication performed between a terminal and another terminal existing inside or outside the BSS.

In general, an IEEE 802.11 based WLAN system may access a medium based on a carrier sense multiple access with collision avoidance (CSMA/CA) method, and each AP may operate separately therein. In the WLAN system, channels may not be assigned by a separate device. Each AP may separately select a channel based on an operator or channel assignment algorithm when the corresponding AP is powered on. Thus, in a case in which a number of WLANs are provided, overlapping channels may be likely to be used in each BSS. When channels overlap, interference may occur between adjacent BSSs.

When radio wave radiation devices not belonging to the same BSS radiate radio waves contrary to the rules at a short distance at which the radio wave radiation devices may have sufficient effects while WLAN communication devices belonging to the same BSS are performing communication pursuant to the rules, the WLAN communication devices may experience communication disruption.

In an existing interference environment WLAN network, a method of avoiding mutual interference using CSMA may be applied. However, in a CSMA protocol, an overall degree of freedom (DoF) of the network may be restricted to a number of AP antennas.

### SUMMARY

According to an aspect of the present invention, there is provided a method for opportunistic interference alignment (OIA) including selecting an interference space, broadcasting information on the selected interference space, selecting a user terminal to be assigned a transmission opportunity for each subchannel based on leakage of interference (LIF) information when a request to send (RTS) message including the LIF information is received from at least one user terminal, and transmitting data to the selected user terminal.

The selecting of the interference space may include determining a transmission vector based on a channel between an access point (AP) and the at least one user terminal.

The determining may include determining the transmission vector based on a signal-to-noise ratio (SNR) of a signal received from the at least one user terminal.

The method may further include transmitting an acknowledgement (ACK) message or a clear to send (CTS) message to a user terminal in response to a received RTS message when the RTS message is received from the user terminal.

The method may further include broadcasting information on a user terminal selected for each subchannel when user terminals are selected for all subchannels.

According to another aspect of the present invention, there is also provided a method for OIA including determining an LIF for each subchannel based on information on an interference space received from an AP, setting a waiting time to transmit an RTS message based on the determined LIF, and transmitting the RTS message to the AP when feedback information is not received from another user terminal within a service range of the AP during the waiting time.

The method may further include resetting the waiting time as infinity when feedback information is received from the other user terminal during the waiting time.

The method may further include resetting the waiting time as infinity when a message indicating that the AP received an RTS message from at least one user terminal is received from the AP during the waiting time.

According to still another aspect of the present invention, there is also provided an AP including a transmission vector determiner to determine a transmission vector based on a channel between the AP and at least one user terminal, a user terminal selector to select a user terminal to be assigned a transmission opportunity for each subchannel based on LIF information when an RTS message including the LIF information is received from the at least one user terminal, and a communication unit to transmit data to the selected user terminal.

According to yet another aspect of the present invention, there is also provided a user terminal including an LIF determiner to determine an LIF for each subchannel based on information on an interference space received from an AP, a waiting time setter to set a waiting time to transmit an RTS message based on the determined LIF, and a communication unit to transmit the RTS message to the AP when feedback information is not received from another user terminal within a service range of the AP during the waiting time.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an example of an interference environment of a wireless local area network (WLAN) according to an embodiment of the present invention;

FIG. 2 is a diagram illustrating a range of channel use of Institute of Electrical and Electronics Engineers (IEEE) 802.11ac according to an embodiment of the present invention;

FIG. 3 is a flowchart illustrating a method for opportunistic interference alignment (OIA) performed by an access point (AP) according to an embodiment of the present invention;

FIG. 4 is a diagram illustrating a method of receiving a request to send (RTS) message for a predetermined subchannel performed by an AP;

FIG. 5 is a flowchart illustrating a method for OIA performed by a user terminal according to an embodiment of the present invention; FIG. 6 is a block diagram illustrating a configuration of an AP according to an embodiment of the present invention; and

FIG. 7 is a block diagram illustrating a configuration of a user terminal according to an embodiment of the present invention.

### DETAILED DESCRIPTION

Hereinafter, the preferred embodiments of the present invention will be described with reference to the accompanying drawings. It is to be understood that the detailed description, which will be disclosed along with the accompanying drawings, is intended to describe exemplary embodiments of the present invention, and is not intended to describe a unique embodiment through which the present invention can be carried out. The following detailed description includes detailed matters to provide full understanding of the present invention. However, it will be apparent to those skilled in the art that the present invention can be carried out without the detailed matters.

The following embodiments are proposed by combining constituent components and characteristics of the present invention according to a predetermined format. The individual constituent components or characteristics should be considered to be optional factors on the condition that there is no additional remark. If required, the individual constituent components or characteristics may not be combined with other components or characteristics. Also, some constituent components and/or characteristics may be combined to implement the embodiments of the present invention. The order of operations to be disclosed in the embodiments of the present invention may be changed to another. Some components or characteristics of any embodiment may also be included in other embodiments, or may be replaced with those of the other embodiments as necessary.

In the following description, specific terminologies used for embodiments of the present invention are provided to help the understanding of the present invention. And, the use of the specific terminology can be modified into another form within the scope of the technical idea of the present invention.

In some cases, to prevent ambiguity in the concept of the present invention, structures and apparatuses of the known art will be omitted, or will be shown in the form of a block diagram based on main functions of each structure and apparatus. Also, wherever possible, the same reference numbers will be used throughout the drawings and the specification to refer to the same or like parts.

Embodiments of the present invention are supportable by standard documents disclosed in at least one of wireless access systems including an IEEE 802 system, a third generation partnership project (3GPP) system, a 3GPP long term evolution (3GPP LTE) system, a long term evolution-advanced (LTE-A) system, and a third generation partnership project 2 (3GPP2) system. In particular, the steps or parts, which are not described to clearly reveal the technical idea of the present invention, in the embodiments of the present invention can be supported by the above documents. Moreover, all terminologies disclosed in this document can be supported by the above standard documents.

The following embodiments of the present invention can be applied to a variety of wireless access systems, for example, Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), and the like. The CDMA may be implemented with radio technologies, for example, Universal Terrestrial Radio Access (UTRA) and CDMA2000. The TDMA may be implemented with radio technologies, for example, Global System for Mobile communications (GSM)/General Packet Radio Service (GPRS)/Enhanced Data Rates for GSM Evolution (EDGE). The OFDMA may be implemented with radio technologies, for example, IEEE 802.11 (Wi-Fi), IEEE 802.16 (WiMAX), IEEE 802-20, and Evolved UTRA (E-UTRA). For clarity, the following description focuses on the IEEE 802.11 system. However, technical features of the present invention are not limited thereto.

In a case of using interference alignment (IA) in a wireless local area network (WLAN), by mapping interference signals received at each receiving end in an interference network to a space having a restricted dimension, an overall degree of freedom (DoF) of the network may increase in proportion to a number of access points (APs), and a sum-rate of the network environment may increase.

The IA may be implemented using various aspects of diversity. In the IA, an opportunistic interference alignment (OIA) method may increase an overall DoF of a network by providing a transmission opportunity to a user terminal with most excellent IA, among a number of user terminals, using multiuser diversity. The OIA refers to a method of aligning and transmitting signals to prevent an interference signal of a lower priority user terminal from affecting a signal of a higher priority user terminal. In a case of the OIA, only a user terminal with most excellent IA may need to be found. Thus, depending on a method of designing a protocol, the IA may be implemented using relatively modest feedback overhead.

Hereinafter, for ease of description, the followings may be assumed. However, the scope of the present invention should not be interpreted as being limited thereto.

(i) It may be assumed that the same channel is used for an uplink and a downlink between an AP and a user terminal or a station (STA). It may be assumed that a channel reciprocity is provided.

(ii) It may be assumed that each user terminal obtaining a transmission opportunity transmits only a single message symbol to an AP in a single message transmission duration. A transmission vector for message transmission may be designed based on a characteristic of a multiple-input multiple-output (MIMO) channel so that an interference effect on another network may be reduced.

(iii) It may be assumed that a noise variance is estimated based on Equation 1.

E[n_{g}′n_{g}]=1 [Equation 1]

In Equation 1, n_{g} denotes a noise vector in an AP network g and E denotes an energy.

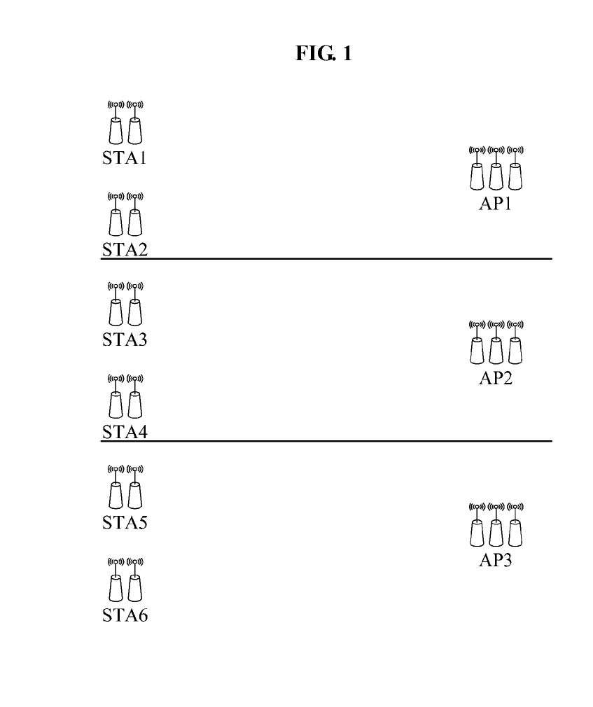

FIG. 1 is a diagram illustrating an example of an interference environment of a WLAN according to an embodiment of the present invention.

Referring to FIG. 1, each AP may include multiple antennas. A plurality of user terminals may be wirelessly connected to each AP. Each of the plurality of user terminals may include at least one antenna.

In a case of a WLAN user, a number of user terminals may access each AP network. Each user terminal may perform communication through an AP network which the corresponding user terminal belongs to. In such an interference environment, each user terminal may perform precoding using multiple antennas during a message symbol transmission process to reduce an interference effect on another AP network.

When a user terminal transmits a signal to an AP network which the user terminal belongs to in a wireless interference channel environment, a signal received by an AP may be modeled as expressed by Equation 2.

$${r}_{g} = {H}_{{Φ}_{g}}^{g} {v}_{{Φ}_{g}} {s}_{{Φ}_{g}} + {\sum }_{x \neq g}^{K} {H}_{{Φ}_{x}}^{g} {v}_{{Φ}_{x}} {s}_{{Φ}_{x}} + {n}_{g} \qquad [ Equation 2 ]$$

In Equation 2, r_{g} denotes a signal vector received at an AP g, H_{Φ}_{ₓ}^{g} denotes a wireless channel matrix between an AP g and a user terminal Φₓ, V_{Φ}_{ₓ} denotes a transmitted signal vector of the user terminal Φₓ, and S_{Φ}_{ₓ} denotes a message symbol of the user terminal Φₓ. The user terminal Φₓ refers to a user terminal that obtains a tranmission opportunity in a network of an AP g. n_{g} denotes a noise vector in the AP g and K denotes the number of APs.

Hereinafter, OIA will be described. When message symbols are transmitted simultaneously in an interference environment multiple AP network, an overall throughput of the network may decrease due to an interference phenomenon. Thus, to prevent the decrease in the throughput, an appropriate interference control may be needed.

In a case of a communication method using OIA, each AP may select a user terminal having a most modest interference effect on another AP network and communicate with the selected user terminal, whereby a decrease in the throughput caused by interference may be prevented. In the OIA, an AP may designate a signal space to be decoded for each AP network. Thus, user terminals may measure leakage of interference (LIF) levels that may affect another network. In this example, an LIF level of each user terminal may be determined based on the following Equation 3. An LIF may include information on interference by another user terminal within a service area of the AP and information on interference by another AP.

$$for a ∈ {Ω}_{g} , {LIF}_{a} = {{\sum }_{x \neq g}}^{K} {\vert {w}_{x}^{H} {H}_{a}^{x} {v}_{a} \vert}^{2} \qquad [ Equation 3 ]$$

In Equation 3, LIFₐ denotes an LIF of a user terminal a, and Ω_{g} denotes a set of user terminals belonging to a network g of the AP. K denotes a number of APs, wₓ^{H} denotes a reception vector with respect to a channel matrix H of an AP x, Hₐ^{x} denotes a wireless channel matrix between an x-th AP (the AP x) and the user terminal a, and Vₐ denotes a transmission vector. In this example, a level of the LIF may decrease as an accuracy of alignment in a space orthogonal to each signal space of each AP having an interference effect increases. A user terminal may coordinate a transmission vector Vₐ to be transmitted, thereby minimizing an LIF level of each user terminal. A method of designing a transmission vector will be described in detail later.

In an OIA based communication method, a user terminal having a lowest LIF level may obtain an opportunity to transmit a message symbol, whereby an interference effect between AP networks may be minimized.

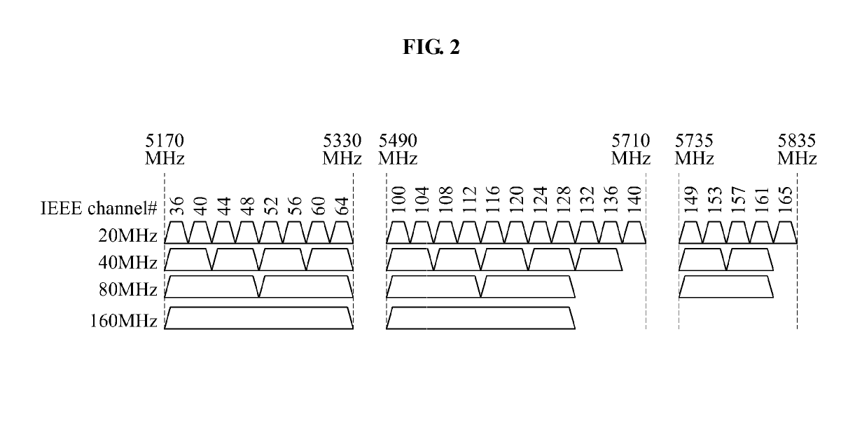

FIG. 2 is a diagram illustrating a range of channel use of IEEE 802.11ac according to an embodiment of the present invention.

In a case of IEEE 802.11ac, a bandwidth up to 160 megahertz (MHz) may be used. Due to the wide bandwidth, it may be inefficient for a single user terminal to use all channels at the same time in terms of frequency selectivity. Thus, an AP may perform OIA coordination by dividing the entire frequency band into a number of subchannels. The OIA coordination performed by dividing the entire frequency band into the subchannels may have the following two advantages.

First, an effect of multiuser diversity may be achieved. In a case in which the entire frequency band is occupied and used by a single user terminal, there may be, in general, a frequency band where a deep fading effect occurs in a channel between the user terminal and an AP communicating the user terminal. In the frequency band where a deep fading effect occurs, it may be difficult to expect an improvement in the overall throughput due to a relatively low signal-to-interference-plus-noise ratio (SINR). In addition, the frequency band where a deep fading effect occurs may cause a strong interference level in a predetermined frequency band, in an aspect of an interfering link. In this example, the throughput in a predetermined frequency band may decrease due to interference transferred from another network. In an implementation of an OIA protocol, when a bandwidth is divided into subchannels and a user terminal is selected for each subchannel, a deep fading effect or a strong interference effect may be highly likely to be prevented based on a number of user terminals, which leads to an increase in the overall throughput of the network.

Second, OIA coordination may be easily performed while communication of IEEE 802.11a is protected, in an aspect of backward compatibility. When the OIA coordination is performed by dividing the entire frequency band into a number of subchannels, the OIA coordination may be easily performed without any restriction in subchannels not being used by user terminals of IEEE 802.11a.

In a subchannel where an existing IEEE 802.11a user terminal performs communication, the existing IEEE 802.11a user terminal and an IEEE 802.11ac user terminal may coexist through a request to send (RTS)-clear to send (CTS) exchange method and thus, an interference effect may be prevented.

An AP may include a base station. The AP may designate a signal vector to be decoded by the AP. A user terminal may calculate an LIF level, and inform the calculated LIF level to the AP. The AP may select a user terminal to be assigned a transmission opportunity for each subchannel based on LIF levels of user terminals. In order to assign a transmission opportunity to a user terminal for each subchannel, an RTS message may need to be transmitted for each channel.

In the IA process, the AP may detect a user terminal having a lowest LIF level, and communicate with the detected user terminal. Thus, a reception of feedback related to an LIF level may be unnecessary. In a control message negotiation for data transmission, the user terminal having the lowest LIF level may have a highest priority, whereby issues may be resolved.

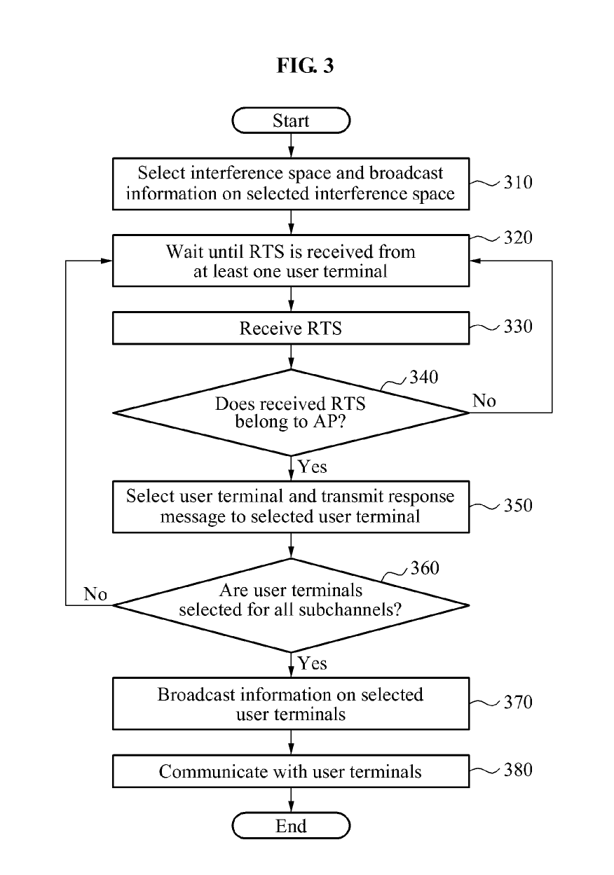

FIG. 3 is a flowchart illustrating a method for OIA performed by an AP according to an embodiment of the present invention.

Referring to FIG. 3, in operation 310, the AP may select an interference space and broadcast information on the selected interference space. The AP may broadcast the information to all user terminals in a network of the AP. The AP may determine a transmission vector based on a channel between the AP and at least one user terminal. In an example, the AP may determine the transmission vector based on a signal-to-noise ratio (SNR) of a signal received from the at least one user terminal. In another example, the AP may calculate a Lagrangian multiplier, calculate a null vector based on a Lagrangian function, and determine the transmission vector based on the null vector.

In operation 320, the AP may wait until an RTS message for a predetermined subchannel is received from at least one user terminal.

In operation 330, the AP may receive an RTS message from at least one user terminal.

When an RTS message is received, the AP may verify whether the received RTS message belongs to the AP, for example, whether the received RTS message was transmitted to the AP, in operation 340. The AP may verify whether the RTS message was received through a subchannel assigned to the AP. When the RTS message does not belong to the AP, the AP may not allow a user terminal having transmitted the RST message to be connected to the AP, and may return to operation 320 and wait until an RTS message is received.

When the received RTS message was transmitted to the AP, the AP may select a user terminal to be assigned a transmission opportunity for the corresponding subchannel, and transmit a response message to the selected user terminal in operation 350. When an RTS message including LIF information is received from at least one user terminal, the AP may select a user terminal to be assigned a transmission opportunity for each subchannel based on the LIF information. The AP may select a user terminal having a lowest LIF level as the user terminal to be assigned the transmission opportunity.

The AP may assign a transmission opportunity for the corresponding subchannel to the user terminal having transmitted the RTS message. When an RTS message is received from a user terminal, the AP may transmit an acknowledgement (ACK) message or a CTS message to the user terminal in response to the received RTS message.

In operation 360, the AP may verify whether user terminals are selected for all subchannels. When user terminals are not selected for all subchannels, the AP may return to operation 320 and wait until an RTS message for another subchannel for which a user terminal is yet to be selected is received, in order to select a user terminal for the other subchannel. The AP may perform operations 320 through 350 with respect to all of the subchannels of the AP.

When user terminals are selected for all subchannels, the AP may broadcast information on the user terminals selected for the respective subchannels of the AP in operation 370. In an example, a message to be broadcast may indicate that a message negotiation is terminated. The AP may broadcast the message to the user terminals connected to the respective subchannels. In this example, the message may include information on the user terminals selected for the respective subchannels. For example, the message may include information regarding which user terminal is connected to which subchannel, and information including physical or logical addresses of the user terminals.

The AP may receive an RTS message for each subchannel and broadcast information on the selected user terminals after an RTS message negotiation for all of the subchannels is completed, thereby simultaneously informing all of the user terminals that the message negotiation for all of the subchannels is completed and that a communication phase is initiated.

When the connections between the AP and the user terminals are completed, the AP may communicate with the user terminals, and transmit a message symbol to the user terminals in operation 380. The AP may communicate with a user terminal selected for a predetermined subchannel. The AP may transmit data to the user terminals selected for the respective subchannels.

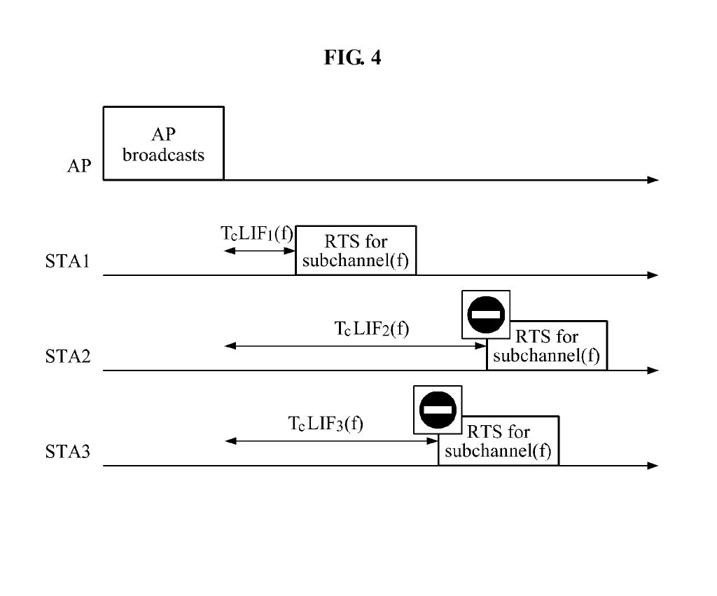

FIG. 4 is a diagram illustrating a method of receiving an RTS message for a predetermined subchannel performed by an AP.

The AP may adjust a period of time during which a user terminal waits to transmit a control message, referred to as a waiting time, to be proportional to an LIF level. For example, when an LIF level for a subchannel f of a user terminal a is denoted by LIFₐ(f), the AP may determine a waiting time during which the user terminal a waits to transmit an RTS message for the subchannel f to be T_{c}LIFₐ(f). In this example, T_{c} is a preset constant.

When other user terminals belonging to the same network do not transmit RTS messages for the subchannel f during T_{c}LIFₐ(f), the user terminal a may transmit an RTS message for the subchannel f to the AP. The AP may transmit an ACK message or a CTS message for the corresponding subchannel in response to a reception of the RTS message for the subchannel f. When an RTS message, an ACK message, or a CTS message is received, the other user terminals belonging to the same network may not transmit RTS messages for the corresponding subchannel during communication between the AP and the user terminal a. The CTS message or the ACK message may include a field configured to transfer a wireless resource block and AP address information.

Each user terminal may set a waiting time during which the corresponding user terminal waits until an RTS message for each subchannel is transmitted, to be proportional to an LIF level.

When a user terminal transmits an RTS message first in a subchannel, the AP may estimate that the user terminal has a lowest LIF level. Thus, when one of user terminals belonging to the same network transmits an RTS message for the subchannel f, the AP may control the other user terminals not to additionally transmit RTS messages for the subchannel f to the AP.

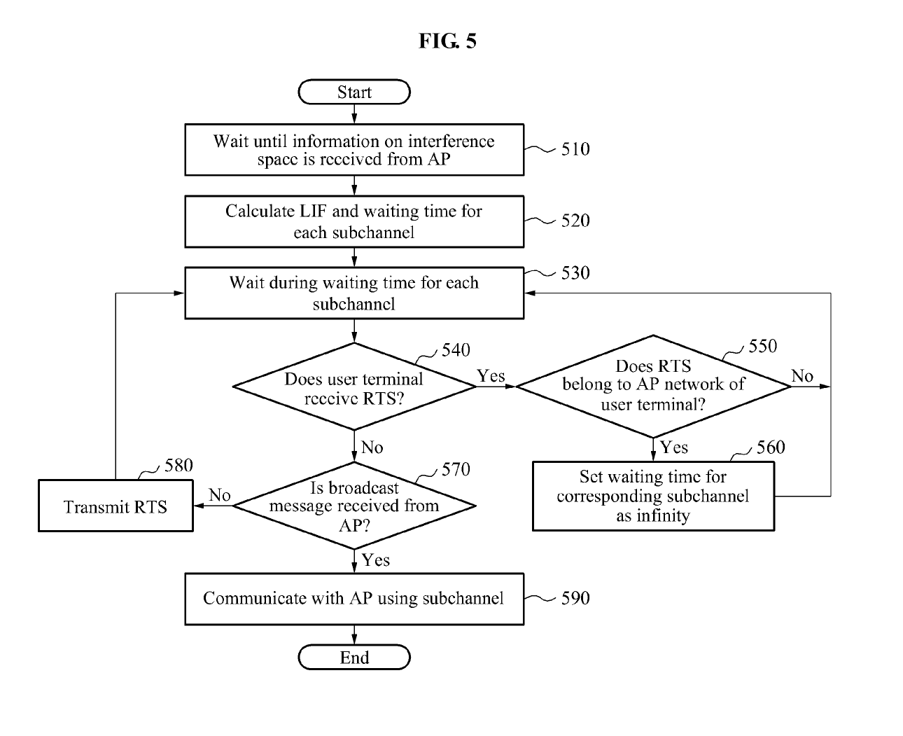

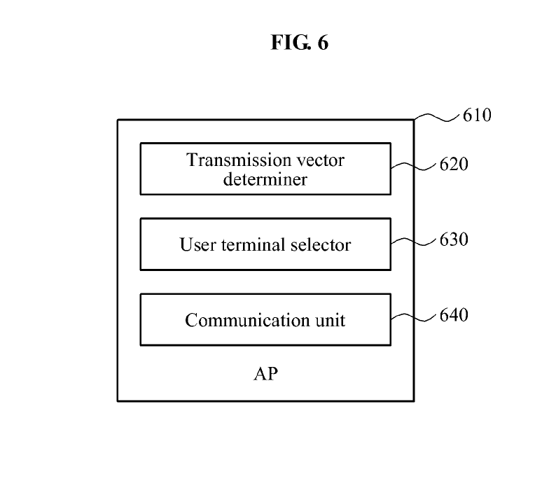

FIG. 5 is a flowchart illustrating a method for OIA performed by a user terminal according to an embodiment of the present invention.

Referring to FIG. 5, in operation 510, the user terminal may wait until information on an interference space is received from an AP.

When information on an interference space is received from the AP, the user terminal may calculate an LIF and a waiting time to transmit an RTS message for each subchannel in operation 520. The user terminal may determine the LIF for each subchannel based on the information on the interference space received from the AP. The descriptions on Equation 3 may be referred to with respect to a method of calculating an LIF. The user terminal may set the waiting time to transmit an RTS message based on the determined LIF. For example, the user terminal may set the waiting time to be proportional to a level of the LIF.

In operation 530, the user terminal may wait a transmission of an RTS message during a waiting time for each subchannel. In an example, the user terminal may wait during a waiting time after information on an interference space selected by the AP is received from the AP.

When the waiting time elapses, the user terminal may transmit an RTS message to the AP. The user terminal may transmit the RTS message to the AP based on a state of a subchannel through which the RTS message is to be transmitted, rather than based on the waiting time.

In operation 540, the user terminal may verify whether an RTS message is received from another user terminal When an RTS message transmitted from another user terminal is received by the user terminal, the user terminal may verify whether the received RTS message belongs to a current AP network of the user terminal in operation 550.

When the received RTS message was received from another user terminal belonging to the current AP network of the user terminal, the user terminal may set the waiting time for the corresponding subchannel as infinity in operation 560. When an RTS message is received from another user terminal during the waiting time, the user terminal may reset the waiting time as infinity to assign a priority to communicate with the AP to a user terminal having transmitted the RTS message first.

As another example, when a message indicating that the AP received an RTS message from at least one user terminal is received from the AP during the waiting time, the user terminal may reset the waiting time as infinity.

When it is verified in operation 540 that an RTS message transmitted from another user terminal is not received, the user terminal may verify whether a broadcast message was received from the AP in operation 570. The broadcast message may refer to a message indicating that a message negotiation with respect to the corresponding AP is terminated.

When a broadcast message is not received from the AP, the user terminal may transmit an RTS message for the corresponding subchannel to the AP in operation 580. The RTS message may include information on an LIF level for each subchannel. The user terminal may transmit the RTS message to the AP when feedback information is not received from another user terminal within a service range of the AP during the waiting time. Operation 580 may be performed after the waiting time determined based on the LIF level elapses.

As described above, when the waiting time elapses, the user terminal may transmit the RTS message to the AP. In this example, when the user terminal receives an RTS message for the corresponding subchannel from another terminal before the waiting time elapses, whether the other user terminal having transmitted the RTS message belongs to a network of the user terminal may be verified. When the other user terminal belongs to the network of the user terminal, the user terminal may not transmit an RTS message for the corresponding subchannel to the AP.

After the user terminal transmits the RTS message, the user terminal may wait until an ACK message or a CTS message is received from the AP.

In operation 590, the user terminal may communicate with the AP using the subchannel through which the RTS message was transmitted. The user terminal may transmit a message symbol to the AP.

FIG. 6 is a block diagram illustrating a configuration of an AP 610 according to an embodiment of the present invention.

Referring to FIG. 6, the AP 610 may include a transmission vector determiner 620, a user terminal selector 630, and a communication unit 640.

The transmission vector determiner 620 may select an interference space to be used by a user terminal. The transmission vector determiner 620 may determine a transmission vector based on a channel between the AP 610 and at least one user terminal and a channel between APs affected by interference. The transmission vector determiner 620 may minimize an LIF level using the transmission vector determined based on a state of the channel between the AP 610 and the at least one user terminal.

The transmission vector determiner 620 may determine the transmission vector based on an SNR of a signal received from the at least one user terminal. The transmission vector determiner 620 may determine the transmission vector based on a maximum-gain based precoding method. The transmission vector determiner 620 may determine a vector that satisfies a target SNR at a receiving end and minimizes a transmission power, based on the channel between the AP 610 and the at least one user terminal. When the AP 610 receives a signal transmitted by the at least one user terminal and decodes a message symbol, the decoded message symbol may be modeled as expressed by Equation 4.

Sₐ=wₐ^{H}Hₐ^{g}vₐsₐ+wₐ^{H}zₐ+wₐ^{H}n_{c} [Equation 4]

Equation 4 expresses a sum of all received interference vectors. wₐ^{H} denotes a transmision vector of an AP a with respect to a channel matrix H, and Hₐ^{g} denotes a wireless channel matrix between an AP g and a user terminal a. vₐ denotes a transmission vector. In the example, an SNR of the received signal except an interference component may be given by |wₐ^{H}Hₐ^{g}vₐ|². Thus, a value of |wₐ^{H}Hₐ^{g}vₐ|² may be determiend to be the SNR, and the transmission vector vₐ that minimizes the trnasmission power may be given by Equation 5.

$${v}_{a} = \frac{\sqrt{S N R} {( {w}_{a}^{H} {H}_{a}^{g} )}^{H}}{{\vert {w}_{a}^{H} {H}_{a}^{g} \vert}^{2}} \qquad [ Equation 5 ]$$

In Equation 5, SNR denotes the SNR of the received signal except the interference component, wₐ^{H} denotes the transmission vector of the AP a with respect to the channel matrix H, and Hₐ^{g} denotes the wireless channel matrix between the AP g and the user terminal a.

As another example, the transmission vector determiner 620 may employ a precoding method using Lagragian based optimization. The transmissino vector determiner 620 may calcaulte a Lagrangian multiplier, calcualte a null vector based on a Lagrangian function, and determine the transmission vector based on the null vector.

TABLE 1
Algorithm

1^{st} step: Lagrangian multiplier calculation
$\frac{1}{λ} = Trace [ {( {\sum }_{k \neq g}^{K} {( {H}_{a}^{k} )}^{H} {w}_{k} {w}_{k}^{H} {H}_{a}^{k} )}^{- 1} {( {H}_{a}^{g} )}^{H} {w}_{g} {w}_{g}^{H} {H}_{a}^{g} ]$
2^{nd} step: transmission vector space decision
$\begin{matrix}{v}_{a} = linearly scaled version of null vector of \\ [ ( {\sum }_{k \neq g}^{K} {( {H}_{a}^{k} )}^{H} {w}_{k} {w}_{k}^{H} {H}_{a}^{k} ) - {λ ( {H}_{a}^{g} )}^{H} {w}_{g} {w}_{g}^{H} {H}_{a}^{g} ]\end{matrix}$
3^{rd} step: transmission vector scaling with constraint
|w_{g}^{H} Hₐ^{g}vₐ|² = SNR

Table 1 is induced from an issue of Lagrangian optimization to define a Lagrangian function and express a method of calculating a vector satisfying conditions.

The inducing process of Table 1 is as follows. The optimization issue for Lagrangian optimization may be expressed by Equation 6.

$$For a ∈ cell g \\ minimize L I {F}_{a} = {\sum }_{k \neq g}^{K} {\vert {w}_{k}^{H} {H}_{a}^{k} {v}_{a} \vert}^{2} \\ Constraint \text{:} {\vert {w}_{g}^{H} {H}_{a}^{g} {v}_{a} \vert}^{2} = S N R \qquad [ Equation 6 ]$$

A Lagrangian function to resolve the issue of Equation 6 may be defined as expressed by Equation 7.

$$\begin{matrix}L ( {v}_{a} , λ ) = {\sum }_{k \neq g}^{K} {\vert {w}_{k}^{H} {H}_{a}^{k} {v}_{a} \vert}^{2} - λ ( S N R - {\vert {w}_{g}^{H} {H}_{a}^{g} {v}_{a} \vert}^{2} ) \\ = {( {v}_{a} )}^{H} ( {\sum }_{k \neq g}^{K} {( {H}_{a}^{k} )}^{H} {w}_{k} {w}_{k}^{H} {H}_{a}^{k} ) {v}_{a} + \\ λ ( S N R - {( {v}_{a} )}^{H} {( {H}_{a}^{g} )}^{H} {w}_{g} {w}_{g}^{H} {H}_{a}^{g} {v}_{a} )\end{matrix} \qquad [ Equation 7 ]$$

To obtain an optimized transmission vector in Equation 7, conditions of the following Equation 8 may need to be satisfied.

$$\frac{\partial L ( {v}_{a} , λ )}{\partial {v}_{a}} = 0 , {\vert {w}_{g}^{H} {H}_{a}^{g} {v}_{a} \vert}^{2} = S N R , positive λ exists . \qquad [ Equation 8 ]$$

A first condition may be arranged as expressed by Equation 9.

$$\begin{matrix}\frac{\partial L ( {v}_{a} , λ )}{\partial {v}_{a}} = ( {\sum }_{k \neq g}^{K} {( {H}_{a}^{k} )}^{H} {w}_{k} {w}_{k}^{H} {H}_{a}^{k} ) {v}_{a} - {λ ( {H}_{a}^{g} )}^{H} {w}_{g} {w}_{g}^{H} {H}_{a}^{g} {v}_{a} \\ = [ ( {\sum }_{k \neq g}^{K} {( {H}_{a}^{k} )}^{H} {w}_{k} {w}_{k}^{H} {H}_{a}^{k} ) - {λ ( {H}_{a}^{g} )}^{H} {w}_{g} {w}_{g}^{H} {H}_{a}^{g} ] {v}_{a} \\ = 0\end{matrix} \qquad [ Equation 9 ]$$

To satisfy the condition of Equation 9, a determinant of

$$[ ( {\sum }_{k \neq g}^{K} {( {H}_{a}^{k} )}^{H} {w}_{k} {w}_{k}^{H} {H}_{a}^{k} ) - {λ ( {H}_{a}^{g} )}^{H} {w}_{g} {w}_{g}^{H} {H}_{a}^{g} ]$$

is necessarily to be “0”. When the determinant corresponds to “0”, a null vector may inevitably exist. The null vector may be proivded as a vector space that minimizes an LIF.

A Lagrangian multiplier that makes the determinant of

$$[ ( {\sum }_{k \neq g}^{K} {( {H}_{a}^{k} )}^{H} {w}_{k} {w}_{k}^{H} {H}_{a}^{k} ) - {λ ( {H}_{a}^{g} )}^{H} {w}_{g} {w}_{g}^{H} {H}_{a}^{g} ]$$

be “0” may be modified as an eigenvalue problem for calculation. When a number of APs is greater than a number of antennas of an AP, a covariance matrix of colored noise

$$( {\sum }_{k \neq g}^{K} {( {H}_{a}^{k} )}^{H} {w}_{k} {w}_{k}^{H} {H}_{a}^{k} )$$

may be proivded as a square matrix having a full rank. Thus, an inverse matrix of

$$( {\sum }_{k \neq g}^{K} {( {H}_{a}^{k} )}^{H} {w}_{k} {w}_{k}^{H} {H}_{a}^{k} )$$

may exist, and a determinant condition may be modified as expressed by Equation 10.

$$det [ I - {λ ( {\sum }_{k \neq g}^{K} {( {H}_{a}^{k} )}^{H} {g}_{k} {g}_{k}^{H} {H}_{a}^{k} )}^{- 1} {( {H}_{a}^{g} )}^{H} {g}_{g} {g}_{g}^{H} {H}_{a}^{g} ] = 0 \\ -> det [ {( {\sum }_{k \neq g}^{K} {( {H}_{a}^{k} )}^{H} {g}_{k} {g}_{k}^{H} {H}_{a}^{k} )}^{- 1} {( {H}_{a}^{g} )}^{H} {g}_{g} {g}_{h}^{H} {H}_{a}^{g} - \frac{1}{λ} I ] \qquad [ Equation 10 ]$$

Accordingly, in a case of the Lagrangian multiplier, the determinant condition may be provided in an inverse form of a positive eigen value of

$${( {\sum }_{k \neq g}^{K} {( {H}_{a}^{k} )}^{H} {w}_{k} {w}_{k}^{H} {H}_{a}^{k} )}^{- 1} {( {H}_{a}^{g} )}^{H} {w}_{g} {w}_{g}^{H} {H}_{a}^{g} .$$

The positive eigen value may be expressed in a form of

$$Trace [ {( {\sum }_{k \neq g}^{K} {( {H}_{a}^{k} )}^{H} {w}_{k} {w}_{k}^{H} {H}_{a}^{k} )}^{- 1} {( {H}_{a}^{g} )}^{H} {w}_{g} {w}_{g}^{H} {H}_{a}^{g} ] ,$$

for example, a sum of diagonal terms.

In the above matrix, a rank of a (Hₐ^{g})^{H}w_{g}w_{g}^{H}Hₐ^{g} term may be given as “1”. Thus, a rank of

$${( {\sum }_{k \neq g}^{K} {( {H}_{a}^{k} )}^{H} {w}_{k} {w}_{k}^{H} {H}_{a}^{k} )}^{- 1} {( {H}_{a}^{g} )}^{H} {w}_{g} {w}_{g}^{H} {H}_{a}^{g}$$

may also be less than or equal to “1”, which indicates that a number of positive eigen values is less than or equal to “1” and a number of remaining eigen values corresponds to “0”, among all eigen values. Thus, it may be intuitively understood that a sum of all eigen values corresponds to the sole positive eigen value. The sum of the eigen values may be obtained using a trace of the matrix, for example, a sum of the digonal terms. Thus, it may be understood that the sole positive eigen value corresponds to

$$Trace [ {( {\sum }_{k \neq g}^{K} {( {H}_{a}^{k} )}^{H} {w}_{k} {w}_{k}^{H} {H}_{a}^{k} )}^{- 1} {( {H}_{a}^{g} )}^{H} {w}_{g} {w}_{g}^{H} {H}_{a}^{g} ] .$$

After the Lagrangian multiplier is calculated, a null vector in a differential form of the aforementioned Lagrangian function may be calculated based on the following Equation 11.

$$[ ( {\sum }_{k \neq g}^{K} {( {H}_{a}^{k} )}^{H} {w}_{k} {w}_{k}^{H} {H}_{a}^{k} ) - {λ ( {H}_{a}^{g} )}^{H} {w}_{g} {w}_{g}^{H} {H}_{a}^{g} ] {v}_{a} = 0 \qquad [ Equation 11 ]$$

The null vector calculated based on Equation 11 may be provided as the vector space that minimizes the LIF, and the transmission vector may be calculated based on SNR constraints.

The communication unit 640 may broadcast information on the selected interference space. The communication unit 640 may transmit the transmission vector determined by the transmission vector determiner 620 to the user terminal. The communication unit 640 may receive an RTS message including LIF information from at least one user terminal. The RTS message may be classified based on a subchannel.

When an RTS message including LIF information is received from at least one user terminal, the user terminal selector 630 may select a user terminal to be assigned a transmission opportunity for each subchannel based on the LIF information. The user terminal selector 630 may select a user terminal having a lowest LIF level as the user terminal to be assigned the transmission opportunity.

The user terminal selector 630 may assign a transmission opportunity for a corresponding subchannel to a user terminal having transmitted an RTS message. When an RTS message is received from a user terminal, the communication unit 640 may transmit an ACK message or a CTS message to the user terminal in response to the received RTS message.

The user terminal selector 630 may verify whether user terminals are selected for all subchannels. When user terminals are not selected for all subchannels, the user terminal selector 630 may select a user terminal based on an RTS message for another subchannel.

When user terminals are selected for all subchannels, the communication unit 640 may broadcast information on the user terminals selected for the respective subchannels. In an example, a message to be broadcast may indicate that a message negotiation is terminated. The communication unit 640 may broadcast the corresponding message to the user terminals connected to the respective subchannels. In this example, the message may include information on the user terminals selected for the respective subchannels. For example, the message may include information regarding which user terminal is connected to which subchannel, and information including physical or logical addresses of the user terminals.

When the connections between the AP 610 and the user terminals are completed, the communication unit 640 may communicate with the user terminals, and transmit a message symbol to the user terminals. The communication unit 640 may transmit data to the user terminals selected for the respective subchannels.

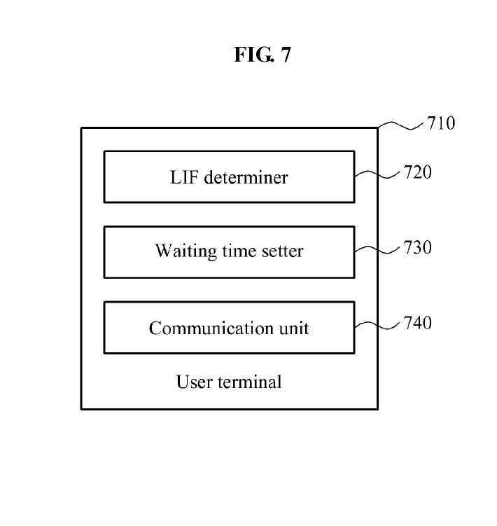

FIG. 7 is a block diagram illustrating a configuration of a user terminal 710 according to an embodiment of the present invention.

Referring to FIG. 7, the user terminal 710 may include an LIF determiner 720, a waiting time setter 730, and a communication unit 740.

The LIF determiner 720 may determine an LIF for each subchannel when information on an interference space is received from an AP. The user terminal 710 may determine the LIF for each subchannel based on the information on the interference space received from the AP. The descriptions on Equation 3 may be referred to with respect to a method of calculating an LIF.

The waiting time setter 730 may set a waiting time to transmit an RTS message based on the determined LIF. For example, the waiting time setter 730 may set the waiting time to be proportional to a level of the LIF.

The waiting time setter 730 may verify whether an RTS message is received from another user terminal. When an RTS message transmitted from another user terminal is received by the user terminal 710, the waiting time setter 730 may verify whether the received RTS message belongs to a current AP network of the user terminal 710. When the received RTS message was received from another user terminal belonging to the AP network of the user terminal 710, the waiting time setter 730 may set the waiting time for the corresponding subchannel as infinity. The waiting time setter 730 may reset the waiting time as infinity when an RTS message is received from another user terminal during the waiting time.

As another example, when a message indicating that the AP receives an RTS message from at least one user terminal is received from the AP during the waiting time, the waiting time setter 730 may reset the waiting time as infinity.

The communication unit 740 may communicate with the AP using the subchannel through which the RTS message was transmitted. The communication unit 740 may transmit a message symbol to the AP. The communication unit 740 may transmit the RTS message to the AP when feedback information is not received from another user terminal within a service range of the AP during the waiting time. The RTS message may include information on an LIF level for each subchannel.

In the communication methods suggested herein, by identifying a user terminal having a lowest LIF level through RTS scheduling based on LIF levels, a reception of LIF feedbacks from all user terminals may be unnecessary. In addition, by managing OIA for each subchannel, multiuser diversity may be maximized, and communication of an existing IEEE 802.11a terminal may be readily protected. In addition, the precoding method suggested herein may achieve an improved sum-rate with low power consumption. Thus, a battery lifespan of the user terminal may increase, and an effect on another network may be reduced.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for opportunistic interference alignment (OIA) performed by an access point (AP), the method comprising:
selecting an interference space;
broadcasting information on the selected interference space;
selecting a user terminal to be assigned a transmission opportunity for each subchannel based on leakage of interference (LIF) information when a request to send (RTS) message comprising the LIF information is received from at least one terminal; and
transmitting data to the selected user terminal.

2. The method of claim 1, wherein the selecting of the interference space comprises determining a transmission vector based on a channel between the AP and the at least one user terminal.

3. The method of claim 2, wherein the determining comprises determining the transmission vector based on a signal-to-noise ratio (SNR) of a signal received from the at least one user terminal.

4. The method of claim 2, wherein the determining comprises:
calculating a Lagrangian multiplier;
calculating a null vector based on a Lagrangian function; and
determining a transmission vector based on the null vector.

5. The method of claim 1, wherein the selecting of the user terminal comprises selecting a user terminal having a lowest LIF level as the user terminal to be assigned the transmission opportunity.

6. The method of claim 1, further comprising:
transmitting an acknowledgement (ACK) message or a clear to send (CTS) message to a user terminal in response to a received RTS message when the RTS message is received from the user terminal.

7. The method of claim 1, further comprising:
broadcasting information on a user terminal selected for each subchannel when user terminals are selected for all subchannels.

8. A method for opportunistic interference alignment (OIA) performed by a user terminal, the method comprising:
determining a leakage of interference (LIF) for each subchannel based on information on an interference space received from an access point (AP);
setting a waiting time to transmit a request to send (RTS) message based on the determined LIF; and
transmitting the RTS message to the AP when feedback information is not received from another user terminal within a service range of the AP during the waiting time.

9. The method of claim 8, wherein the setting comprises setting the waiting time to be proportional to a level of the LIF.

10. The method of claim 8, further comprising:
resetting the waiting time as infinity when an RTS message is received from the other user terminal during the waiting time.

11. The method of claim 8, further comprising:
resetting the waiting time as infinity when a message indicating that the AP received an RTS message from at least one user terminal is received from the AP during the waiting time.

12. The method of claim 8, wherein the RTS message comprises information on an LIF level for each subchannel.

13. An access point (AP) comprising:
a transmission vector determiner to determine a transmission vector based on a channel between the AP and at least one user terminal;
a user terminal selector to select a user terminal to be assigned a transmission opportunity for each subchannel based on leakage of interference (LIF) information when a request to send (RTS) message comprising the LIF information is received from the at least one user terminal; and
a communication unit to transmit data to the selected user terminal.

14. The AP of claim 13, wherein the transmission vector determiner determines the transmission vector based on a signal-to-noise ratio (SNR) of a signal received from the at least one user terminal.

15. The AP of claim 13, wherein the transmission vector determiner calculates a Lagrangian multiplier, calculates a null vector based on a Lagrangian function, and determines the transmission vector based on the null vector.

16. The AP of claim 13, wherein the user terminal selector selects a user terminal having a lowest LIF level as the user terminal to be assigned the transmission opportunity.

17. A user terminal comprising:
a leakage of interference (LIF) determiner to determine an LIF for each subchannel based on information on an interference space received from an access point (AP);
a waiting time setter to set a waiting time to transmit a request to send (RTS) message based on the determined LIF; and
a communication unit to transmit the RTS message to the AP when feedback information is not received from another user terminal within a service range of the AP during the waiting time.

18. The user terminal of claim 17, wherein the waiting time setter sets the waiting time to be proportional to a level of the LIF.

19. The user terminal of claim 17, wherein the waiting time setter resets the waiting time as infinity when feedback information is received from the other user terminal during the waiting time.

20. The user terminal of claim 17, wherein the waiting time setter resets the waiting time as infinity when a message indicating that the AP received an RTS message from at least one user terminal is received from the AP during the waiting time.
